(19) United States
(12) Patent Application Publication
(10) Pub. No.: US 2005/0233660 A1
(43) Pub. Date: Oct. 20, 2005

(54) Textile constructions

(76) Inventors: William C. Kimbrell, Spartanburg, SC (US); John L. Sanchez, Moore, SC (US)

Correspondence Address: Terry T. Moyer, P.O. Box 1927, Spartanburg, SC, 29304, US

(21) Appl. No.: 10/948,724

(22) Filed: Sep. 23, 2004

Related U.S. Application Data
(63) Continuation-in-part of application No. 10/825,820, filed on Apr. 16, 2004.

(51) Int. Cl. B32B 5/18; B32B 5/22; B32B 27/04; B32B 27/12

(52) U.S. Cl. 442/76; 442/2; 442/33; 442/43; 442/49; 442/50; 442/58; 442/149; 442/150; 442/151; 442/286; 442/295; 442/299; 442/412

(57) ABSTRACT

Moisture permeable textile constructions are disclosed. The face side of the construction comprises a low energy surface; the reverse side of the construction may carry an adhesive that allows the construction to be securely attached to a support surface, yet may be readily removable without residue or damage to the support surface. The low energy surface may be printed, patterned, or otherwise treated to provide decorative and/or functional characteristics, as desired, depending on the intended use of the construction. Various chemical additives such as stain release agents, biocides, etc. may be incorporated into the construction.

### CROSS-REFERENCE TO RELATED APPLICATIONS

This application is a continuation-in-part of commonly assigned U.S. patent application Ser. No. 10/825,820, filed Apr. 16, 2004.

### TECHNICAL FIELD

This disclosure is directed to a series of textile constructions, useful for covering a variety of surfaces, comprising a textile substrate that has a low energy surface and provides for the movement of moisture through the substrate. In one embodiment, the face of the textile substrate is provided with a low energy surface treatment and the back of the textile substrate is provided with an adhesive. The resulting textile substrate/adhesive composite can be firmly yet releasably affixed to a clean, smooth surface.

It has been found that this textile substrate/adhesive composite is particularly well-suited for use as a wall or ceiling covering for interiors. In spite of its ability to remain securely attached to a support surface for years, embodiments of this composite can be easily removed and repositioned during the installation process, and, when desired, can be easily removed without damage to any conventional underlying support surfaces. Additionally, the composite is substantially non-self-sticking, face-to-back (allowing it to be rolled up without the use of release paper or the like), substantially residue-free when removed (allowing re-application of the composite), soil and stain resistant (due to its low energy surface) and, if desired, can be made to be easily cleanable, mildew resistant, or to have other properties, depending upon the chemistry associated with the various layers comprising the composite.

The textile substrate portion of the composite may be manufactured without an integral adhesive layer if the desired adhesive is to be applied separately (to the textile, to the support surface, or to both) at the time of installation. However, unless otherwise specified, the various embodiments of the textile constructions discussed herein will involve a textile substrate/adhesive composite that is manufactured as such, rather than one that is created in situ at the time of installation using the textile substrates and adhesives disclosed herein.

When used in place of conventional wall coverings, the substrate/adhesive composite described herein provides an attractive alternative to wallpaper and wallpaper borders by overcoming a multitude of problems faced by those installing, using, and removing conventional wallpaper. Conventional wallpaper, usually comprising sheets of paper or vinyl, is attached to the wall using either adhesive backings that are activated by wetting the wallpaper (in the case of prepasted wallpapers) or wallpaper paste that is spread on the back of the wallpaper or on the wall itself (in the case of unpasted wallpapers). After wetting or applying adhesive, the wallpaper is “booked” or folded in a specialized way to minimize the extent to which the adhesive comes into contact with the face of the wallpaper. These installation methods are tedious for all but the most sophisticated installers, typically requiring many messy, time-consuming steps and mandating the use of water trays, brushes, smoothing rollers, drop cloths, razor blades, and a host of other tools, the purchase of which adds additional cost for the installer.

Many wallpaper hanging failures are caused by poor surface preparation before hanging. Surface preparation includes, at a minimum, washing the walls to remove any dirt, grease, or grime that may have accumulated over time. If the walls are unfinished, however, as in the case of new construction, finishing the walls requires spackling, sanding, and, possibly, priming the walls with a base coat of paint or primer.

From the standpoint of surface preparation, perhaps an even worse situation is presented if the walls are already wallpapered. Once installed, the permanence of many conventional wall coverings tends to exceed their useful life. In many cases, the process of removing conventional wall coverings rivals, and arguably surpasses, the installation process for being time-consuming, difficult, and tedious. Often, conventional wallpapers are multiple-layered structures that tend to separate during the removal process, requiring removal of the wallpaper layer by layer. Also common is the situation in which the wallpaper itself will not come off the wall in uniform, whole sheets, but rather in irregular, shredded pieces, frequently (and undesirably) accompanied by portions of the underlying wall finish, a situation that adds wall surface repair to the list of surface preparation activities. Like installation, removal has its own set of specialized tools: chemical sprays or gels, paper scoring tools, steamers, scrapers, and the like.

A problem sometimes encountered with conventional wall coverings, but potentially more problematic, is the presence of moisture at the interface between the wall and the wall covering, as would occur due to the migration of moisture through the wall. This condition, which frequently is undetectable until considerable damage is done, can cause poor performance in the form of sagging or bulging of the wall covering as the moisture causes the wall covering to lose its grip on the underlying support surface, but can also be a major contributor to mold growth, disintegration of the wall surface, and other very significant problems.

Other challenges addressed by conventional wallpaper with only limited success include the ability to maintain a clean and new-looking appearance (especially in cases involving textured wallpapers, as might be created by embossing) and the ability to resist damage from being accidentally gouged by furniture or other objects.

In its various embodiments, the textile construction described herein successfully addresses these problems. The use of this textile construction generally minimizes the time required for wall preparation, as the textile substrate, when used with an appropriate adhesive, is capable of adhering to any dry, dust-free, solid surface that is relatively smooth. A surprising advantage of this construction is its ability to mask minor wall defects and imperfections, ranging from screws and nail holes to unfinished drywall seams to small-scale depressions or contusions in wallboard. This ability to mask defects translates into a time savings for installers whose time would be otherwise spent preparing the wall surface.

Where an integral adhesive layer is used to form a textile substrate/adhesive composite, the need for messy or wet adhesives is eliminated. However, with careful selection of the adhesive, a textile substrate/adhesive composite of the kind described herein can provide several additional advantages when used in wall covering applications. For example, it can be rolled up on itself, eliminating the need for “booking” or other specialized handling. Hanging the composite requires only a roller (or some other means to apply uniform force) and a razor blade-type cutter (for cuts at the ceiling and/or floor). The composite can be temporarily removed and repositioned multiple times, if necessary, on the wall, as might be desirable when aligning patterns of adjacent composite panels. Furthermore, the composite is constructed to transport moisture away from the wall surface, which can effectively address the problems of lack of grip, mold growth, wall disintegration, and other problems associated with moisture trapped under a wall covering.

Generally, adhesives that are pressure sensitive (i.e., contact adhesives that remain permanently tacky when dry) or releasable (i.e., adhesives that will readily allow removal without leaving residue on, or damage to, the support surface), and particularly the latter, are more suitable for use in connection with the textile constructions disclosed herein. In many embodiments, adhesives that are both pressure sensitive and releasable will be particularly advantageous.

Embodiments of the textile construction described herein include a stain resistant low surface energy treatment, but may further include a stain release treatment. Such treatment would allow the composite to resist most kinds of stains and, in many cases, would allow the user to remove stains that become absorbed into the composite, thereby addressing yet another problem associated with many conventional wall coverings.

Because the substrate may be secured to the wall with an appropriate pressure sensitive adhesive (e.g., as part of a textile substrate/adhesive composite), it is easily removed, with virtually no tools, from the wall without leaving substantial adhesive residue on the wall and without substantially damaging the wall.

Because of a relatively high tear strength (e.g., a recommended minimum trap tear strength of at least about 5 pounds or more, and preferably about 10 pounds or more, with higher values being preferred, in both the “machine” and “cross-machine direction” (as defined herein), as measured using ASTM Test Method D-5733-99, with this minimum value being substantially isotropic), the textile substrate (or substrate/adhesive composite) is removable in the monolithic form in which it was hung. This feature is the result of the engineered relationship between the substrate's tear strength and the (lower) peel strength of the adhesive. The pressure sensitive adhesives recommended for these applications tend to exhibit long-term stability in use, meaning that the bond strength between the adhesive and the wall neither weakens nor strengthens significantly over time. Although non-releasable adhesives may be used in installing the textile constructions and forming the textile substrate/adhesive composites described herein, it should be understood that use of a releasable, pressure sensitive adhesive will best assure that the textile substrate can be removed with minimum effort at any time (even years) after initial installation. It should be noted that, to ensure clean removal in some situations, the application of one or more (dry) coats of a suitable primer paint to the support surface prior to hanging the substrate/adhesive composites may be advisable, depending upon the adhesive used, the nature of the underlying support surface, and other factors.

This relative ease of removability provides an opportunity for decorating to those who might not otherwise be able to hang wallpaper or be willing to undergo the many steps associated with the installation of conventional wall paper. For example, the textile substrate/adhesive composite easily can be used in apartments and dormitory rooms, where occupants are instructed not to permanently modify the walls, or in decorating a child's room to satisfy a requirement that the room décor be modifiable to fit the child's changing tastes. In hotels, offices, and other commercial settings, the easy removability of a substrate/adhesive composite constructed as disclosed will allow for the easy replacement of damaged areas. Furthermore, the composite can be constructed to include with various additives, such as flame retardants, mildew inhibitors, and the like, to enhance the performance of the composite for its specific intended environment.

Details of various embodiments and their advantages are discussed below with reference to the following Figures.

### DESCRIPTION OF DRAWINGS

FIG. 1 is a schematic cross-sectional view of one embodiment of the textile construction described herein, showing a low surface energy layer 12 on the face of the textile substrate 14 and an optional primer 16 on the back of substrate 14. Adhesive layer 18 is shown attached to primer 16, but could be attached directly to the back of substrate 14. Interstices in the substrate and the low surface energy layer that allow for the transport of moisture through the substrate are present but not shown.

FIG. 2 is a schematic cross-sectional view of another embodiment of the textile construction described herein, in which textile substrate 22 is comprised of low surface energy yarns, meaning yarns that, inherently or intrinsically, have outer surfaces that are low energy surfaces (thereby establishing low energy surface 21 on the face of substrate 22) and carries an adhesive layer 26 on the back. An optional primer 24, positioned between the back of the textile substrate 22 and an adhesive layer 26, is also shown. Interstices in the substrate that allow for the transport of moisture through the textile, although present, are not shown.

FIG. 3 is a schematic cross-sectional view of another embodiment of the textile construction described herein, showing a low surface energy layer 32 on the face of textile substrate 34. A primer layer 36, on the back of the textile substrate 34, is also shown. Interstices in the substrate and the low surface energy layer that allow for the transport of moisture through the textile, are present but not shown.

FIG. 4 is a schematic cross-sectional view of yet another embodiment of the textile construction described herein, showing a textile substrate 42 with low energy surface 41, an optional primer layer 44, and adhesive layer 46, and a release sheet 48 next to adhesive layer 46.

FIG. 5 is a schematic representation, in plan view, of a woven substrate/adhesive composite 50, in which the spaces between individual yarns (e.g., 51 through 55) have been exaggerated. Not shown, although present, is a low surface energy layer on the face of substrate 50, and, on the back of substrate 50, an adhesive layer and an optional primer layer, positioned between the adhesive layer and the back of the textile. The cross-section indicated at 6-6 is depicted in FIGS. 6A and 6B

FIG. 6A is a schematic cross-sectional view, taken along lines 6-6 of the substrate/adhesive composite of FIG. 5, as the composite would appear when lightly pressed against a support surface. The area of adhesive contact with the surface is indicated at AA.

FIG. 6B is a also a schematic cross-sectional view, taken along lines 6-6 of the substrate/adhesive composite of FIG. 5, as the composite would appear when firmly pressed against a support surface. The area of adhesive contact with the surface is indicated at AB, and is to be compared with the corresponding area AA indicated in FIG. 6A.

FIG. 7A shows a representation of one method of covering a wall 70 with rolls of an substrate/adhesive composite 72 that are installed in adjacent and matching fashion. In practice, the installer places one end of composite 72 at the upper edge of wall 70 and lightly applies composite 72 to wall 70. The installer then unrolls composite 72 and applies an unrolled portion of composite 72 to wall 70, cutting as necessary with cutter 74. Should one strip of composite 72 become misaligned, it can be easily removed for repeated repositioning, as necessary.

FIG. 7B shows a representation of the method of FIG. 7A, except that the composite 76 has a meandering side edge (here, shown as an arc), designed to accommodate or align with the side edge of the adjacent panel, for the purpose of disguising the seams between adjacent panels of composite 76. It should be noted that, although rectangular panels are shown, panels of other appropriate sizes and shapes would work equally well.

FIG. 8 is a process flow diagram of individually-conventional steps that can be used to manufacture a substrate construction or substrate/adhesive composite as described herein.

### DETAILED DESCRIPTION

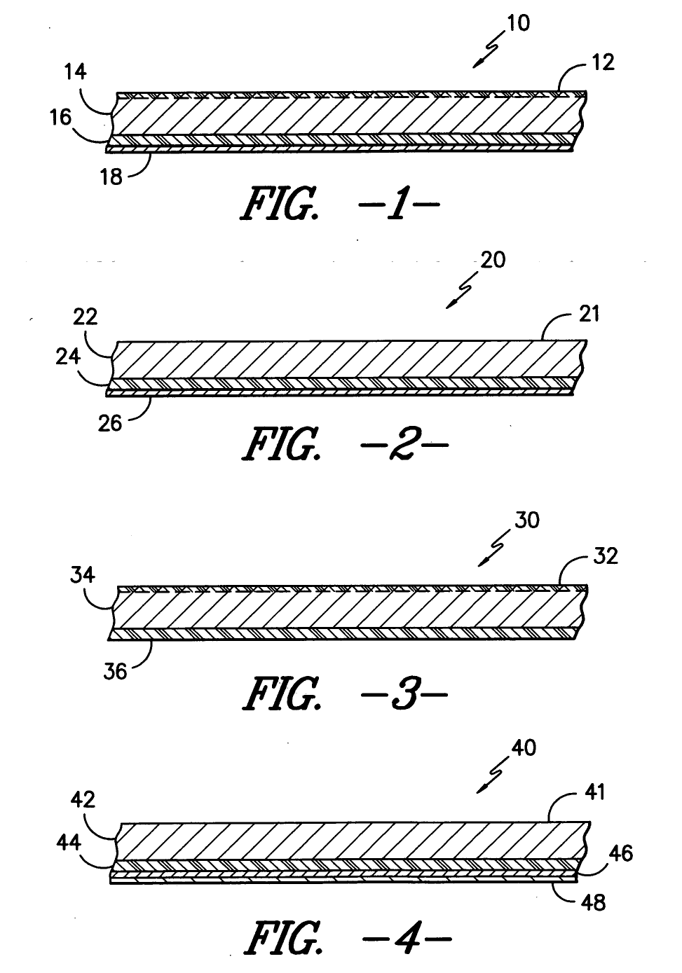

This disclosure is directed to several embodiments of a moisture-permeable textile construction useful for decorating or protecting interior (or suitably protected exterior) surfaces. In the embodiment of FIG. 1, textile substrate 14 has a low surface energy treatment in the form of layer 12 on its face and an optional primer layer 16 on its back, to which is attached an adhesive layer 18. The resulting substrate/adhesive composite 10 therefore includes both a low energy surface 12 and an adhesive layer 18, both of which are at least partially incorporated into textile substrate 14. Penetration of adhesive 18 into textile substrate 14 is desirable for creating strong physical bonds between the various components, thereby preventing delamination (that is, separation) at a later time and assuring that the composite 10, when peeled from a support surface, will leave little or no residue. It has also been found that adhesive penetration can reduce fraying of the composite following cutting.

It should be noted that the degree of penetration into textile substrate 14 of both low surface energy treatment 12 and adhesive 18 may be controlled based on the application technique. The degree of penetration is difficult to depict accurately in a Figure, and would depend to some degree upon the presence of optional primer layer 16. Specifically, the depiction of the degree of penetration shown in FIG. 1 is intended to be representative, rather than limiting. By way of example, when applied by padding, low surface energy treatment 12 is typically absorbed throughout textile substrate 14, rather than existing as a discrete layer within the fabric, as depicted in FIG. 1. Foaming low surface energy treatment 12 into textile substrate 14 may be preferable, because the foamed low surface energy treatment 12 will not penetrate fully throughout substrate 14, thereby enabling the deeper penetration of adhesive 18 into substrate 14 (due to the tendency for the low energy surface to disrupt the proper attachment of adhesive 18 to the yarns and fibers of substrate 14).

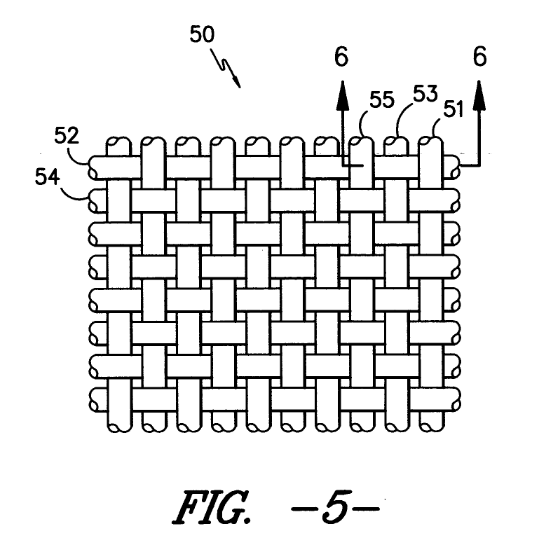

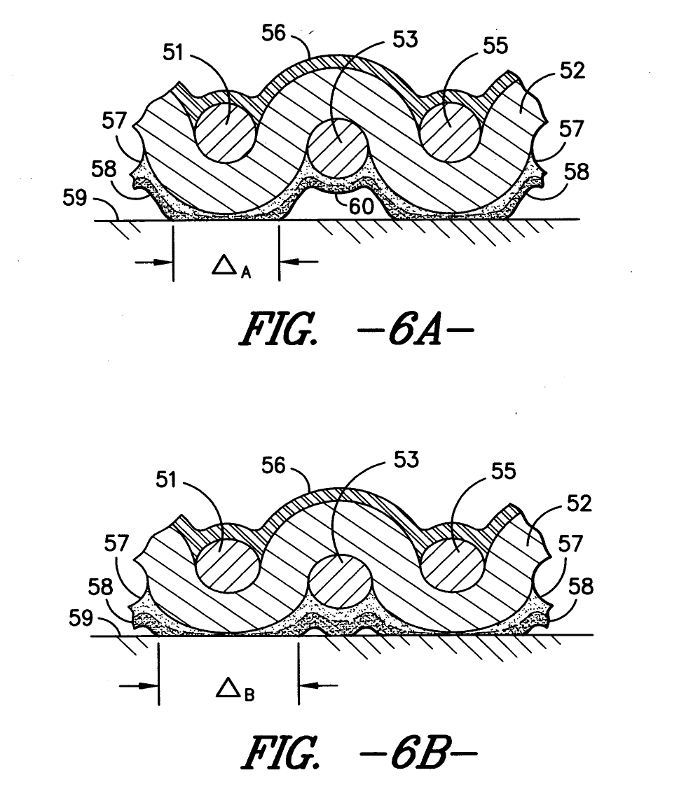

FIG. 2 depicts a construction 20 similar to that of FIG. 1, but without a low surface energy layer. Here, the textile substrate derives its low energy surface from being constructed from individual yarns with low energy surfaces, either as a result of composition (e.g., polyester) or of the low surface energy treatment of the individual yarns prior to the textile substrate formation process. As in FIG. 1, an optional primer layer 24 is shown. FIG. 3 depicts a textile construction 30 similar to the embodiment of FIG. 1 (showing low surface energy layer 32 and an optional primer layer 36). For this embodiment, attachment to a support surface would involve the application of an adhesive to the back of textile substrate 34 (or, if present, to the primer layer 36), to the support surface, or both, at the time of installation. The embodiment of FIG. 4 is intended to show the use of a release paper; for this purpose, the embodiment of FIG. 2 (with adhesive layer 26) was selected (although the embodiment of FIG. 1 could have been used) to depict the situation in which low energy surface 41 is insufficient to prevent the self-adhering of the textile substrate/adhesive composite 40 to the desired degree. These and other embodiments will be discussed below.

Because a principal anticipated use for the substrate/adhesive composites of FIGS. 1 and 2 is as a decorative or protective wall covering, this composite may be referred to in this disclosure as a wall covering, but without intention to limit its many other potential uses or the generality of the teachings herein. This composite, when constructed with an appropriate choice of textile substrate, low energy surface treatment (if needed), adhesive, additives, and an appropriate overall structure (including the optional use of reinforcing layers of various kinds to provide additional tear strength, puncture resistance, or other desired attribute), can be adapted for use in a variety of applications or on a variety of support surfaces. It is contemplated that the nature of the adhesive (e.g., releasable, pressure sensitive, permanent, etc.) may be used in combination with the textile constructions disclosed herein, as circumstances may require.

However, the disclosure is not limited to such composite. It is contemplated that the adhesive and textile substrate may be separately applied to a support surface, using, for example, the structure depicted in FIG. 3, thereby forming the textile substrate/adhesive composite structure described herein in situ. It is further contemplated that, in another embodiment, again similar to that depicted in FIG. 3, the textile substrate portion of the composite may be used with any suitable adhesive, regardless of its releasable nature (or lack thereof), in situations in which the aesthetics of a textile substrate are to be combined with the advantages of a decorative surface that is capable of transmitting moisture and that, optionally, may also exhibit some of the other attributes discussed herein, e.g., being easily cleanable, soil resistant, mildew resistant, etc.

Although principal uses of the textile constructions (with and without various adhesive layers) disclosed herein include wall coverings and other applications in which relatively light-weight substrates (of the kind generally referred to as textile substrates) are normally preferred, it is contemplated that thicker and/or heavier textile substrates, including pad-like or carpet-like substrates, for example, could be successfully employed in selected end uses, so long as they are otherwise suitable, e.g., are sufficiently flexible to conform to the target surfaces, provide for the movement of moisture, etc. Where the wall covering is to remain on the wall for years without peeling or sagging, yet maintain its qualities of removability and releasability, without harm to the underlying wall surface or leaving a residue upon ultimate removal, the physical weight of the substrate should not exceed the peel strength of the adhesive or the composite, as applied to the support surface, with an appropriate margin of safety.

Textile Substrates

Throughout this discussion, the textile substrate (and, as context requires, the composite as well) will be referred to as having a face (i.e., that side that would be outwardly facing following application of the composite to a support surface such as a wall) and a back (i.e., that side that would be directly opposite and in contact with the wall or other support surface to which the composite is attached). In most cases, the front and reverse of the textile substrate portion of the composite will be identical in construction prior to the formation of the composite, and, due to the three dimensional nature of the yarns or fibers from which textile substrates are typically constructed, the front and reverse will each exhibit a degree of contouring or texturing, particularly in areas where the individual yarns or fibers overlap or are intertwined, that may be characterized on a yarn or fiber diameter scale. Such contouring shall be referred to as “fine scale” contouring or texturing, to distinguish it from the moderate or large scale contouring that is associated with, e.g., embossed textile substrates, or napped or pile textile substrates, especially those having nap or pile yarns at different heights.

The textile substrate may be constructed from any suitable textile fibers, filaments, or yarns. Such fibers or yarns may be comprised of commonly available materials such as nylon, polyester, polypropylene, acrylic, olefins (e.g., polyethylene or polypropylene), cellulosic materials (e.g., rayon or cotton), wool, blends thereof, and other materials (e.g., silk, linen, various aramids, fiberglass, etc.). It should be understood that the discussion of any specific polymer herein is intended to include both homopolymers and co-polymers thereof.

It should also be understood that the nature and construction of the textile substrate is dependent upon the desired overall physical and aesthetic characteristics of the textile construction or composite, as well as the available or desired process steps to be carried out during fabrication of the composite. Thus, if a wall covering is to provide some sound absorption properties or contribute significant aesthetic “weight” to an interior surface, the selected textile substrate might have a napped or pile face, or might be constructed using tufting or bonding techniques. Similarly, if an overall low energy treatment following the substrate formation steps is to be avoided due to, for example, process limitations, the preferred low energy surface characteristic may be obtained through the use of yarns having inherently low surface energy, such as polyester yarns, to construct the substrate. It should be noted, however, that where such low surface energy yarns are used, the presence of such yarns on the reverse of the substrate may adversely affect the attachment of adhesive or other layers to the back and may also adversely affect the degree of adhesion achieved when the substrate is attached to a support surface.

Generally, synthetic fiber types are preferred over natural fibers because of their resistance to microbial degradation and their tendency to resist swelling when wet. Among synthetic fibers, polyester is preferred over nylon, because of its inherently low energy surface and attendant resistance to permanent staining. The selected yarn (or yarns, if different types are used) optionally may be solution dyed, as where accent yarns in the final product are desired or where yarns particularly suited to solution dyeing (e.g., polypropylene) are used. The yarns may be textured or untextured, depending on the desired appearance and desired end use characteristics of the composite.

Possible constructions of the textile substrate include various types of weaving and knitting, as well as the use of non-woven constructions. Most nonwoven substrates have a tendency to resist unraveling or fraying when cut, which may be advantageous in some applications and would obviate the need for binders, etc. When used as a wall covering, it may be advantageous that the textile substrate have a relatively smooth face, although it is foreseen that the face may be contoured or patterned or may have a knitted or pile construction. Tufted or bonded substrates having a pile or napped surface may also be used. The construction of the textile substrate should have sufficient physical strength and dimensional stability to allow it, or any composite of which it is a part, to be applied to a surface, peeled from the surface, and be re-applied to the surface, in repeated fashion, without tearing or compromising the geometry of the composite. Regardless of the composition or construction, the textile substrate should be capable of transmitting moisture, if the benefits of moisture transport as disclosed herein are desired.

The amount of stretch in the textile substrate affects the ease with which the substrate/adhesive composite is handled and installed. A limited degree of stretch in either the machine or cross-machine direction is generally acceptable, depending upon the desired visual effect of the applied composite. As used herein, the terms “machine” and “cross-machine” shall refer, respectively, to the warp and fill of woven textiles, the wales and courses of knit textile substrates, and, for non-woven textile substrates, the respective direction of textile substrate movement through the substrate formation machine (the “machine direction”) and the direction perpendicular to that movement direction (the “cross-machine direction”). In certain applications—for instance, when conforming the composite to a curved or other three-dimensional surface, or allowing a controlled amount of the wall or ceiling surface to show through the covering, or establishing a specific degree of texture to a surface a higher degree of stretch may be desirable. Contrariwise, when aligning multiple rows of a patterned or printed composite with one another as, for example, when the composite is used as a wall covering with a repeating pattern, a minimal degree of stretch may be preferable in order to preserve design geometry from panel to panel. To provide such minimal stretch, any of several techniques may be employed, either individually or in appropriate combination, such as using a relatively stretch-resistant substrate construction, applying greater amounts of binder or an additional layer (e.g., of polyurethane, acrylic polymers, and various copolymers or other additives) to the back of the textile substrate before applying the adhesive, and heat-setting the substrate in its stretched state (which tends to minimize additional stretch).

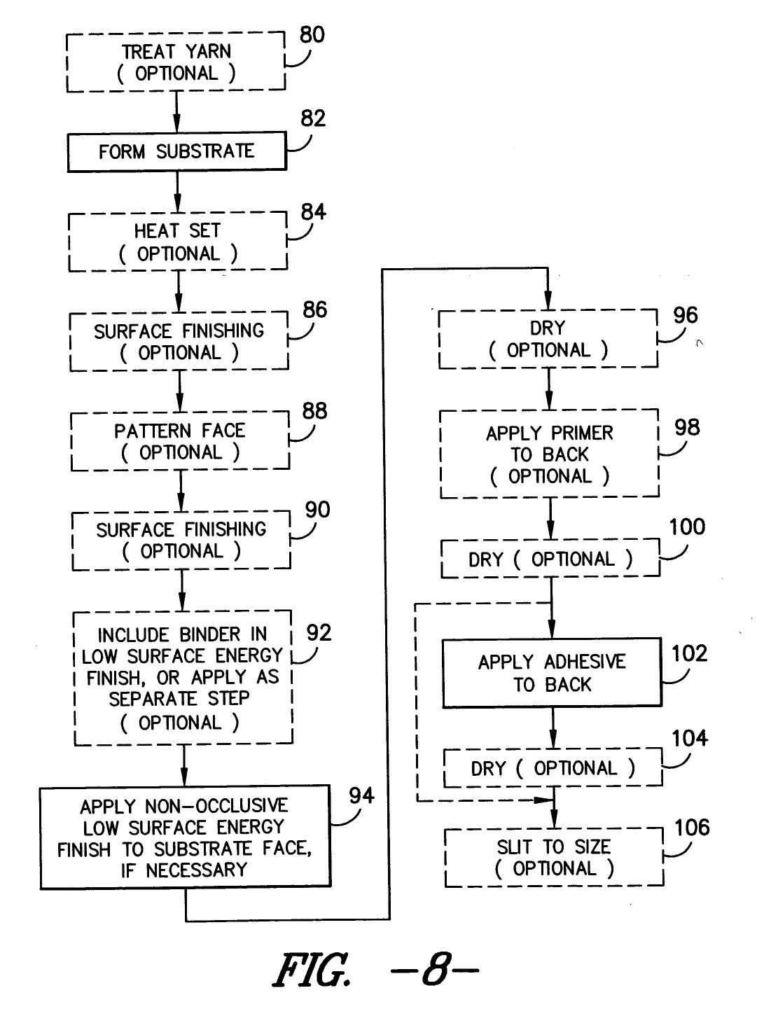

Wall coverings typically take the form of panels comprising a strip of convenient width that is wrapped into a roll for storage and transport. Such panels typically have straight, parallel sides (and are hung as shown in FIG. 7A). However, as depicted in FIG. 7B, such strips may have curved or otherwise irregular edge geometry that eliminate straight abutting seams between adjacent wall panels that are easy to detect visually in favor of a “meandering” seam (i.e., one that changes direction over some practical distance along the length of the panel—for example, an edge geometry having a pattern that repeats every several feet) that tends to disguise such seam. It is also contemplated that “random match” patterning, or patterning that is visually forgiving of small vertical or lateral displacements, can assist in hiding seams between adjacent panels.

A textile substrate that was formed with only fine-scale contouring (i.e., one considered a “flat” textile substrate) may be treated on one or both sides to establish a more exaggerated contoured surface. Creating such contours in the substrate can be achieved as part of the substrate formation process (e.g., by jacquard weaving, dobby weaving, circular knitting, tricot knitting, warp knitting or Raschel knitting), or can be achieved or enhanced during a subsequent step. Representative processes that could be used include localized yarn shrinkage or melting by heated fluid streams (e.g., as disclosed in commonly assigned U.S. Pat. No. 5,148,583); yarn dislocation by high velocity fluid streams (e.g., as disclosed in commonly assigned U.S. Pat. No. 5,235,733); yarn deformation as by, for example, embossing; and yarn melting or degradation, including chemical etching and degrading, as will be known to those skilled in the art.

Following formation of the substrate, the face and/or the back of the resulting substrate optionally may be subjected to various appropriate surface finishing operations, such as napping, sanding, brushing, or the like. The substrate then may be optionally subjected to a heat setting step to stabilize the textile's width and shrinkage characteristics, as desired. In most instances, surface finishing may be used to improve the appearance, texture, or hand of the face of the textile. However, it is contemplated that some surface finishing techniques may be employed on the back of the textile, for example, to further improve the adhesion between the substrate and the adhesive component or other optional components. For example, plasma treatment, of the kind generally described in commonly assigned U.S. Pat. No. 6,096,156, involving either the yarns or the formed substrate, may provide a means for improving adhesion.

This collection of techniques is intended to be non-exclusive, and it is contemplated that two or more techniques may be used on the same substrate, and that other conventional processes may readily be used or adapted for use in modifying the appearance of the substrate as may occur to those skilled in the art.

The substrate also may be printed or dyed, for example, to create aesthetically pleasing decorative designs on the textile. The substrate may be colored by a variety of dyeing and/or printing techniques appropriate to the fibers or yarns, such as high temperature jet dyeing with disperse dyes, thermosol dyeing, pad dyeing, transfer printing, screen printing, digital printing, ink jet printing, flexographic printing, or any other technique that is common in the art for comparable textiles. Printing may be done in-line with substrate formation or at a later time. In addition, the fibers or yarns comprising the substrate may be dyed by suitable methods before substrate formation, such as, for instance, by package dyeing, solution dyeing, or beam dyeing, or they may be left undyed. In one embodiment, it is contemplated that the substrate be printed with solvent-based dyes rather than aqueous dyes in cases where solvent-based dyes may be more compatible with the adhesive release agents described herein.

The face side of the substrate or composite is comprised of a low energy surface. The low energy nature of the surface may be achieved by use of intrinsically hydrophobic and oleophobic yarns, by the application of a low surface energy agent such as fluorocarbons, silicones, or waxes to the yarns prior to or following the substrate formation process, or perhaps a combination of these techniques. When the low surface energy treatment is applied as a discrete layer, it allows for the front and back of the substrate to have different surface energy properties that are more suited to their respective functions. While this embodiment, particularly when combined with an integral layer of an appropriate adhesive on the reverse side that collectively forms the textile substrate/adhesive composites discussed at length below, it should not be assumed that this embodiment is necessarily preferred to the other embodiments disclosed and discussed in various levels of detail herein. In any case, the low energy surface is preferably moisture permeable, i.e., capable of allowing moisture from the back of the composite to pass through the composite to the front.

The degree of moisture permeability associated with the substrate is dependent upon the inherent permeability of the selected low surface energy agent as well as the occlusive/non-occlusive character of any layer formed by such agent. Permeability relates to the ability of a continuous layer to allow the convective or non-convective transport of moisture. “Occlusivity” in this context refers to the formation of obstructions to the convective flow of gas or vapor through a substrate. If the layer is comprised of a moisture permeable material that is applied in non-occlusive fashion to the surface of a substrate (i.e., so that the natural interstices present in the substrate remain unblocked), one can expect a high degree of moisture transport through the substrate. Conversely, if the layer is comprised of a relatively moisture impermeable material that is applied occlusively to the surface of a substrate (i.e., so as to form a substantially continuous layer on the substrate that tends to occlude or block the natural interstices present in the substrate), one can expect a low degree of moisture transport through the layer, as is found with conventional vinyl covered wallpapers.

As a working generalization (with significant exceptions), it is believed that the degree of occlusiveness of the layer dominates the inherent permeability characteristics of the material, thereby causing an non-occlusive layer of an impermeable material to exhibit a higher degree of moisture transport than an occlusive layer comprised of an inherently permeable material. This implies that the application of any materials in the form of coatings, treatments, or layers such as those listed herein either should be done non-occlusively or, if done occlusively, should involve only materials that are inherently moisture permeable.

In one principal embodiment, a low surface energy treatment is applied to the textile substrate to yield a non-occlusive layer that more-or-less conforms to the surface of individual yarns comprising the substrate and provides interstitial passages for the convective passage of water vapor from the back to the front of the textile. If applied to at least the face of the substrate or textile substrate/adhesive composite, the low surface energy treatment prevents any of the adhesive component associated with the back of the substrate or composite from sticking to the face of the textile substrate when the composite is rolled up into a cylinder (e.g., in packaging). This attribute is particularly useful in situations where the substrate/adhesive composite will be rolled up for long periods, possibly experiencing a wide fluctuation in temperatures and humidity. It also provides benefit in preventing the adhesive component from bleeding or seeping through to the face of the textile substrate (also known as “strike-through”) during manufacture or in cases where an adhesive is applied to the back of the substrate or directly to the wall or other support surface at the time of installation. This treatment further provides water repellency to the substrate/adhesive composite, and may, depending on its composition, also provide oil repellency. Both types of repellency are helpful in resisting stains during use.

To obtain a low energy surface on the face of the substrate or composite, the substrate may be treated with an agent that provides both hydrophobic and, preferably, at least some oleophobic character. Such agents include waxes, silicones, certain hydrophobic resins, fluoropolymers, and the like, and combinations thereof. Fluoropolymers are low surface energy agents particularly suitable for this application. Non-limiting examples of such fluoropolymers include REPEARL® F8025 fluoropolymer and REPEARL® F-89 fluoropolymer, both available from Mitsubishi International Corporation of New York, N.Y., and ZONYL® 7713 fluoropolymer, available from E.I. DuPont deNemours of Wilmington, Del. Useful chemical compositions for this purpose are also the subject of U.S. patent application Ser. No. 10/340,300, filed Jan. 10, 2003, to Kimbrell, Jr. et al. and commonly assigned to Milliken & Company, the disclosure of which is hereby incorporated by reference in its entirety.

Aqueous emulsions of silicon-based compounds, including, for example, emulsions in which the silicone is cross-linked, are also useful as low surface energy agents, although they tend to exhibit relatively modest oleophobic character. Numerous silicon-based compounds may be employed over a wide range of molecular weights such as those containing polysiloxanes, including, for example, polydimethyl siloxane and dimethyl hydrogen polysiloxane.

Natural or synthetic waxes or mixtures thereof may also be applied as a low surface energy treatment. Suitable naturally occurring waxes include mineral waxes such as crystalline or amorphous paraffin, vegetable waxes, and animal waxes such as beeswax. Suitable synthetic waxes include fatty alcohols and acids, fatty acid esters, and glycerides.

In addition to the low surface energy treatments discussed above, it may be desirable to use a soil or stain release agent, either alone or, preferably, in combination with the low surface energy agents described above, to impart soil or stain release properties to the textile. Stain release agents include ethoxylated polyesters, sulfonated polyesters, ethoxylated nylons, carboxylated acrylics, cellulose esters or ethers, hydrolyzed polymaleic anhydride polymers, polyvinyl alcohol polymers, polyacrylamide polymers, fluorinated stain release polymers, ethoxylated silicone polymers, polyoxyethylene polymers, polyoxyethylene-polyoxypropylene copolymers, and the like, and combinations thereof. Fluorinated stain release agents that may be effective (and which are intended only as examples and not to be limiting) include a fluoropolymer sold by Daikin Corporation under the trade name UNIDYNE® TG-992; a fluoropolymer sold by Mitsubishi Corporation under the trade name REPEARL® SR1100; and a fluoropolymer sold by E.I. DuPont deNemours under the trade name ZONYL® 7910.

Various other additives, collectively referred to herein as “optional treatments,” may be incorporated into the face side of the substrate/adhesive composite to impart desired properties to the composite. The following discussion is intended to be exemplary, rather than exhaustive. It is contemplated that additives other than those discussed below, as are known to those skilled in the art, may also be incorporated into or onto the face or back of the substrate as part of an optional treatment. Such additives may also be incorporated into the fibers or yarns of the substrate before the substrate formation process.

By way of example, it may be desirable to treat the substrate with finishes containing chemicals such as biocides, flame retardants, ultraviolet stabilizers, photo catalysts, antioxidants, coloring agents, lubricants, antistatic agents, radio-frequency shielding additives, fragrances, odor absorbers or neutralizers, and the like, or combinations thereof. Application of such finishes may be by immersion coating, padding, spraying, foam coating, or by any other technique whereby a controlled amount of a liquid suspension may be applied to a textile substrate. Many such chemical compositions can be incorporated simultaneously with the low surface energy agent, or such compositions may be applied before treatment with the low surface energy agent and/or stain release agent. It is also possible, using appropriate techniques, to apply many such chemical compositions after treatment with the low surface energy and/or stain release agent, using, e.g., exhaustion techniques.

It is further possible to incorporate many of the chemical additives listed above into a “primer” layer or into the adhesive component. This layer is commonly comprised of an inexpensive polymer or thickened adhesive. Where a primer layer is used, it typically is applied to the back of the textile to add bulk and tune the surface morphology of the final composite. However, the primer layer can serve a variety of other purposes, including preventing later-applied adhesive from passing through to the face of the substrate, improving adhesion between the substrate and any later-applied adhesive layer attached to the back of the composite, and providing a convenient carrier for other functional additives such as biocides, flame retardants, moisture transport-promoting fillers or structures (e.g., bubbles), etc. (it should be understand that such additives can also be placed in the substrate, in an adhesive layer, or elsewhere in the composite. If applied as an occlusive layer, the primer layer should be moisture permeable. Note that this primer layer is different from any paint primer layer that may be applied to the support surface to seal or protect it from damage at such time as the substrate or substrate/adhesive composite is removed from such surface. As mentioned elsewhere, such paint primer layer may be recommended in connection with the use of some types of adhesives or support surfaces, or if other circumstances suggest such need.

The low surface energy agent and any optional treatments may be applied simultaneously or sequentially to the textile substrate. For example, the agents may be combined in one solution, perhaps with a cross-linking agent, and then simultaneously applied to the textile substrate by padding. After application of the chemical agent(s) to the textile substrate, the treated substrate is generally exposed to a drying step to evaporate excess liquid, leaving the solid active components on the surface of the treated substrate. In yet another embodiment, a stain release agent is applied to the textile substrate, and then the low surface energy agent is applied to either a wet or dry substrate, creating a non-occlusive, layered chemical treatment on the surface of the substrate.

Drying can be accomplished by any technique typically used in manufacturing operations, such as dry heat from a tenter frame, microwave energy, infrared heating, steam, superheated steam, autoclaving, or the like, or any combination thereof. It may be desirable to expose the treated substrate to an additional heating step to further enhance the performance or durability of the chemical agent(s). By way of example, additional heating may (a) enable discrete particles of the active components of the chemical agents to melt-flow together, resulting in uniform, cohesive film-like layers; (b) induce preferred alignment of certain segments of the chemical agents; or (c) combinations thereof.

It is contemplated that, as an alternative to the low surface energy treatments in those cases where an adhesive has been applied to the back of the textile, it may be desirable in some applications to use release sheets that are removably attached to the adhesive component (as shown in FIG. 3C). As known in the art, “release sheets” are typically used to protect the adhesive component from contamination during subsequent processing (e.g., slitting, printing, and packaging), as well as preventing undesirable self-sticking when an adhesive-backed substrate is rolled up. The user manually removes the release sheets before applying the composite to the selected surface.

Release sheets, and methods for their preparation, are well known. Typically, the release sheet comprises a support sheet, such as craft paper, which is coated or impregnated on one surface (the “release surface”) with a suitable release material, such as a silicone or wax, which possesses properties of good release with respect to the adhesive component so that the installer can readily remove the release sheet at a later date. Release sheets may be incorporated into a textile substrate/adhesive composite through adhesive transfer coating, where the adhesive is first coated onto the release sheet and the adhesive side of the release sheet is pressed against the back of the textile. The release sheet can be left in place and the composite rolled up for storage. When unrolled, the user can remove the release sheet, which leaves the adhesive attached to the textile substrate. It should be understood that use of such release sheets should not interfere with the moisture permeability of the substrate following installation, nor preclude the use of desired optional treatments to the face of the substrate or composite.

Adhesives

In some embodiments, the textile substrate is part of a substrate/adhesive composite that carries an adhesive on the back of the textile. More specifically, use of such combination of adhesive and substrate can result in a substrate/adhesive composite that, regardless of the duration of attachment, i.e., from mere seconds to multiple years, will allow the substrate to be removed without tearing or substantially damaging the underlying surface, or leaving substantial adhesive residue remaining on the surface. Restated in more technical terms, such substrate/adhesive composites have significant structural integrity, and the adhesive has a peel strength less than its cohesive strength and less than the strength of the surface to which it is applied (to prevent damage to the surface). Throughout this entire disclosure, the term pressure sensitive, as used to describe an adhesive, shall refer to a contact adhesive that remains permanently (i.e., over a period of years) tacky when dry, and the term releasable, as used to describe an adhesive, shall refer to an adhesive that is readily removable without leaving a significant residue or causing damage to the surface to which it was attached. The substrate/adhesive composites disclosed herein generally will include, as an adhesive, a releasable and/or pressure-sensitive adhesive, or a thermoplastic hot-melt polymer.

A number of factors must be weighed in choosing the appropriate adhesive type and amount, and the choice of any such combination should be made with the following listing of attributes in mind (which listing represents a non-exhaustive set of desirable, but collectively non-essential attributes). It is foreseen that satisfactory adhesives may exhibit many or most, but not necessarily all, of these attributes and may, for some applications, require characteristics not listed or otherwise discussed below. The adhesive should form a strong and enduring bond with the back of the textile substrate (that is, the side to which the adhesive is applied) and a firm but releasable bond with the support surface. The adhesive should exhibit relatively high cohesive strength and not leave any significant residue on the support surface after the textile substrate is removed (included in the definition of a releasable adhesive given above). The adhesive should possess long-term stability from the standpoint of having the bond between the composite and support surface neither weaken nor strengthen significantly over time, independent of environmental conditions.

There should be little or no bonding between the adhesive and the face of the textile substrate (e.g., in situations where the composite is rolled into a cylinder for transport or storage, the composite should be non-self-adhering, i.e., there should be little or no bonding where the adhesive back contacts the low surface energy face of the textile). The bond between adhesive surfaces, in cases where the adhesive side of the composite accidentally contacts itself, should be easily breakable (i.e., the adhesive should be non-blocking).

Advantageously, the substrate or substrate/adhesive composite will be readily re-positionable, i.e., it will maintain its attributes of removability and clean releasability, with no stretching or tearing, through repeated cycles of application and removal, with the ability to be re-adhered to the same or different support surface for a period of at least a few days or weeks following initial installation (as might occur where the substrate is used as a wall covering, and the wall covering needed repositioning at the time of installation or shortly thereafter).

It is recognized that the property of transporting moisture (e.g., from the back to the face of the substrate/adhesive composite) can be of significant importance in many applications. The substrate or substrate/adhesive composite described herein provides an aesthetically pleasing surface that is moisture permeable, yet tear resistant and dimensionally stable, and that may be applied to a wall or other surface using an adhesive that is applied to the back of the substrate, to the support surface, or both (in the case of the substrate/adhesive composite, the adhesive has been pre-applied to the substrate), with or without the addition of any optional layers or treatments.

Just as the low surface energy treatment described herein is non-occlusive or otherwise designed to provide for the transport of moisture through the textile, the adhesive similarly should be selected and applied in a manner that results in an adhesive layer that also allows for the passage of moisture, although this does not necessarily mean that the adhesive layer must be applied in a non-occlusive manner. The composition of the adhesive layer may allow the layer to be occlusive (i.e., be applied as a coating, by conventional coating means), yet remain capable of transmitting moisture (e.g., by diffusion or other mechanisms). As discussed below, it has been found that pressure sensitive adhesives, particularly emulsion-type pressure sensitive adhesives, generally meet this requirement.

Pressure Sensitive Adhesives

Pressure sensitive adhesives typically are either of a solvent-based type, an emulsion type, or a hot-melt type. The characteristics and application methods of each will be described as follows in connection with the embodiment in which an adhesive layer is attached to the back of the textile, thereby forming an integrated textile substrate/adhesive composite that can be applied to a support surface at a later time without additional adhesive. It should be understood that these adhesives may be applied to, and become part of, such an integrated textile substrate/adhesive composite, or may be applied separately to the back of the substrate, to the support surface (i.e., the wall), or possibly both, at the time of installation, without the prior formation of such composite (i.e., thereby forming a textile substrate/adhesive composite in situ at the time of installation). Furthermore, it should be understood that solvent- or emulsion-based adhesives that happen to be neither pressure sensitive nor readily releasable (e.g., conventional wall paper paste) may be applied to the substrate or the wall immediately before installation, with many of the advantages of the textile construction (e.g., moisture permeability, stain resistance, non-self-adherence, strength, appearance, etc.) remaining.

Emulsion-type pressure sensitive adhesives generally have more desirable properties because of their ease of use in manufacturing. These types of aqueous-based adhesives are more easily used than solvent-based adhesives, which typically contain volatile organic compounds and may require more complex environmental safeguards. Hot-melt pressure sensitive adhesives have the advantage of not requiring a drying step.

Examples of emulsion-type pressure sensitive adhesives include an acrylic polymer adhesive sold under the trade name MULTI-LOK® 38-454A and a vinyl acetate adhesive sold under the trade name NACOR® 72-8761, both available from National Starch & Chemical of Bridgewater, N.J. Methacrylate-based pressure sensitive adhesives may also be used, an example of which is ROBOND© PS-8120 HV sold by Rohm & Haas of Philadelphia, Pa. Other classes of adhesives that may be used are documented in the reference book Handbook of Pressure Sensitive Adhesive Technology, edited by Don Satas and published by Van Nostrand Reinhold Co. (1982). In some instances, it may be desirable to use a permanent or high strength adhesive when applying a textile composite to stronger surfaces such as metal or brick or for permanent installations.

Emulsion type-pressure sensitive adhesives may be modified through the use of various additives to change characteristics such as tack, peel strength, cohesive strength, stiffness, and the like. Examples of such additives include, without limitation: (1) wetting agents, such as wetting agents sold by Air Products under the trade name SURFYNOL® PSA-336 and by Union Carbide under the trade name TRITON® GR-5M; (2) mechanical stabilizers, such as a mechanical stabilizer sold by Union Carbide under the trade name TRITON® X-200 and by Dow Chemical under the trade name DOWFAX® 2A1; (3) thickening agents, such as a thickeners sold by Rohm and Haas under the trade names ACRYSOL® ASE-60 and ACRYSOL® TT-615; (4) cross-linking agents, such as a cross-linker sold by Ultra Additives under the trade name ZINPLEX® 15; (5) tackifying agents, such as tackifiers sold by Arizona Chemical under the trade name AQUATAC® 6085, by Akzo Nobel under various trade names, and by Eastman Chemical under various trade names; (6) detackifiers, or hardeners, such as a vinyl acetate homopolymer sold by Rohm & Haas under the trade name ROVACE® 177; (7) defoaming agents, such as a defoaming agent sold by Cognis under the trade name FOAMSTER O® and by Crompton/Witco under the trade name BUBBLE BREAKER® 3056A; (8) a plasticizing agent, such as that sold by Velsicol Chemical under the trade name BENZOFLEX® 50. Similar additives for solvent-based adhesives, as are known in the art, may be incorporated into solvent-based pressure sensitive adhesives. Emulsion- and solvent-type pressure sensitive adhesives may be applied using conventional coating methods as may be known in the art, including, but not limited to, back-coating, knife coating, foam coating, kiss coating, or other suitable techniques.

Hot-melt pressure sensitive adhesives have the advantages of providing a relatively high add-on when compared with solvent- or emulsion-type pressure sensitive adhesives, and, furthermore, do not require drying. One example of a suitable hot-melt pressure sensitive adhesive is a rubber co-polymer sold by National Starch and Adhesives under the trade name EASYMELT® 34-591A. Hot melt adhesives can be applied by any of a number of commonly known coating technologies such as slot orifices, rolls, and extrusion coaters.

As discussed previously, with all adhesives, an optional primer layer may be used to improve adhesion between the textile substrate and the adhesive component and provide other advantages. Surface finishing on the back of the textile substrate may also improve the bond of the adhesive component to the textile substrate.

Thermoplastic Hot-Melt Polymers

Thermoplastic hot-melt polymers, including olefins and acrylates (such as polymethylmethacrylate), are also suitable for use as the adhesive component of a substrate/adhesive composite, although moisture permeability is much lower in olefin-type adhesives. Typically, these polymers are extruded directly onto the surface of the textile substrate or are extruded as films that are subsequently laminated onto the substrate. Various types of desired additives, as will be described, may be incorporated directly into the polymer mix before extrusion. Unlike the pressure sensitive adhesives described above, thermoplastic hot-melt polymers exhibit little or no tack at room temperature. As a result, low surface energy agents or release sheets are optional when using thermoplastic hot-melt polymers as part of a substrate/adhesive composite, but the use of low surface energy agents is recommended if, for example, stain repellency and/or ease of cleaning the surface of the composite is important.

Thermoplastic hot-melt polymers require the application of heat and pressure to fix the substrate/adhesive composite to a desired surface. This process can be accomplished by the use of any standard household iron, heat gun, or the like. Removal of thermoplastic hot-melt polymer-containing composites is much different from those containing pressure sensitive adhesives. In the case of thermoplastic hot-melt polymers, removal without reheating may be extremely difficult and may cause significant surface damage.

Surface Contact

As discussed above, textiles, regardless of construction, possess certain fine-scale surface contours that result from the types of yarns and formation processes used to create the textile substrate. For instance, whereas film or paper generally has a relatively flat (smooth) surface profile, a textile product has a fine-scale contoured surface profile caused by the presence of fibers within the yarns and the positioning of the yarns within the textile.

Such fine-scale surface contours can provide a simple means for making significant adjustments to the tack and peel strength of the adhesive and of any substrate/adhesive composite. For example, when used with a constant, relatively low adhesive add-on level, composites that incorporate relatively flat, low-contour substrates lacking significant fine scale contouring will exhibit a greater accessible surface area for contact with the surface to which it is applied, as compared with a substrate having significant fine scale contouring. The latter substrate will appear, on a microscopic level, to have a relatively “bumpy” (that is, highly contoured) surface, and will only actually contact the wall or other support surface at the tops or peaks of the bumps.

Accordingly, substrate/adhesive composites that utilize textile substrates lacking such fine scale contouring (e.g., where the textile surface has been layered with a substance that tends to “fill in” the contours and provide a relatively flat surface) will exhibit a comparatively larger amount of tack and peel strength when applied to a surface due to its larger surface contact area. The inherent contour of the textile substrate, as well as the quantity and nature of adhesive applied to the back of the textile substrate, can be adapted to provide the desired amount of adhesive strength. The use of primers or physical modifications to the surface (such as calendaring) may be used to reduce the degree of contour and thereby provide increased contact surface area between the substrate and the support surface and correspondingly increased adhesion for a given adhesive add-on.

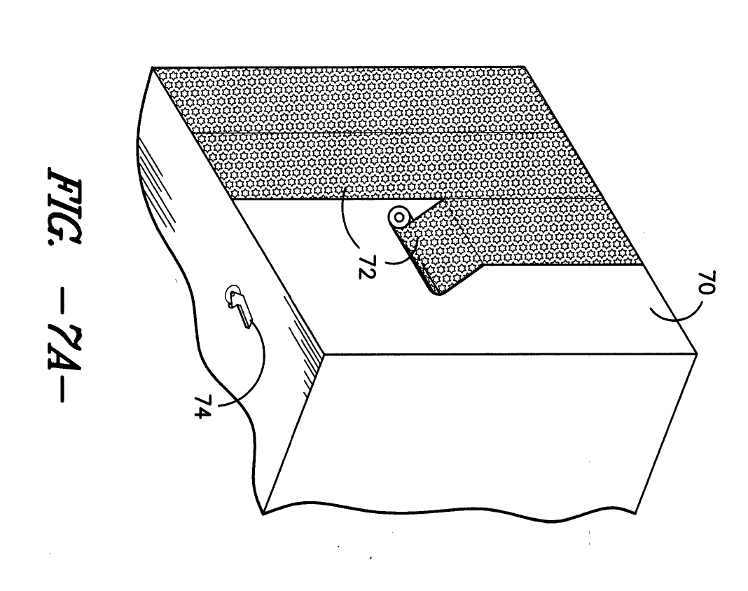

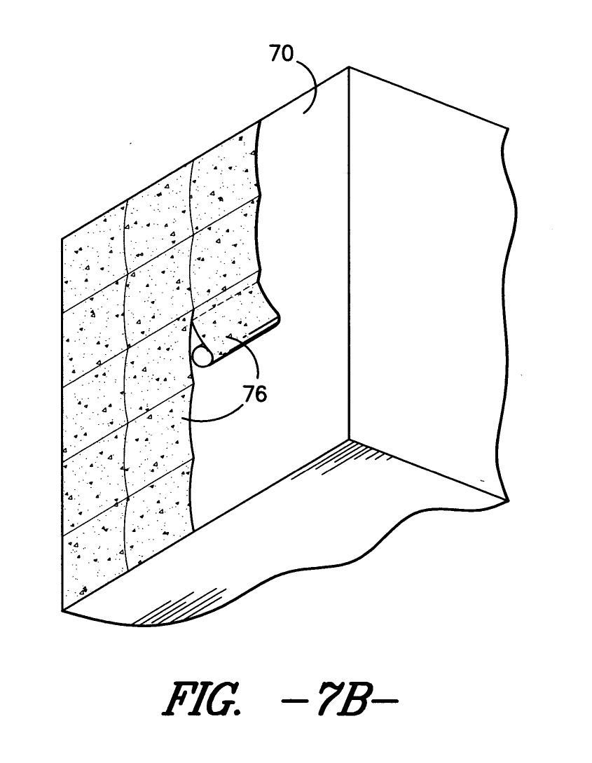

However, in cases where the textile substrate exhibits fine scale contouring even following the application of an adhesive layer, the degree of adhesion with a given support surface may be increased through the application of pressure over the textile substrate face as part of the process of affixing the composite to the support surface. Such pressure is believed to deform and reconfigure the fine scale contours of the back of the textile substrate to provide increased surface contact area between the adhesive associated with the back of the textile substrate and the support surface. It is believed that the “peaks” tend to be flattened against the support surface and a portion of those areas adjacent to the peaks that would not otherwise have come into contact with the support surface are made a part of the effective surface contact area. This mechanism is depicted in FIGS. 6A and 6B. In FIG. 6A, the distance AA indicates the degree of surface contact between the adhesive layer 58 and the support surface 59 to be expected with relatively light pressure used to affix the composite to the support surface. FIG. 6B depicts the corresponding distance AB to be expected with relatively firm pressure used to affix the composite to the support surface. In addition to the increased surface area depicted by the larger distance defined by AB, it should also be noted that some portions of the adhesive layer, such as depicted at 60 in FIG. 6A, may be brought into contact with the support surface, further increasing the available adhesive contact area. Thus it is possible to have a composite exhibit low peel strength, when desired, through the use of low application pressures at the time of installation so that the composite is easy to reposition. Thereafter, higher pressure will produce a stronger bond for long term adhesion.

The fine scale contours discussed above are also believed to provide a means for controlling the adhesion between the back of the composite and the face of the composite when the composite is rolled into a cylinder for storage or shipment (i.e., controlling the “non-self-adhering” nature of the composite). The problem of preventing self-adhesive sheet goods from sticking to themselves is well-recognized, and has been addressed in the prior art with varying degrees of success as to effectiveness, convenience, and cost. Without being bound by theory, it is believed that, when rolled into a cylinder, the face side of the composites described herein present a smaller contact surface area (i.e., only the “peak” areas of the fine-scale textile surface) with respect to the adhesive surface directly opposite, thereby reducing the potential grip that can be established between the rolled layers of composite and providing release points that aid in the unrolling of the composite. The presence of the low energy surface on the face of the textile substrate also contributes substantially to the relatively non-self-adhering character of this composite.

Although the adhesive component of choice, particularly if applied as a layer to the back of the textile, commonly will cover substantially all the back surface of the textile, it is contemplated that a discontinuous covering of adhesive may also be used. Such a discontinuous application can be achieved by the use of a slot die extrusion method, an engraved roll, screen printing, and other techniques as may be known by those of skilled in the art. The discontinuous application can form a predetermined pattern or can be random.

Slitting the textile-adhesive composite to prevent fraying may be accomplished using techniques that heat-seal the edges, namely hot knife cutting, ultrasonic cutting, and laser cutting. If the textile composite exhibits low fraying, non-sealing cutting methods may be used, such as shearing, scoring, or knife cutting. Other techniques that minimize fraying include the use of nonwoven textile substrates, the non-occlusive application of a polymer composition or laminate to the textile substrate before application of the adhesive, impregnating the textile substrate with a polymer composition such as a size or a binder, and fully or partially impregnating the textile substrate with the adhesive component. Candidate binders include the following: Rhoplex K-3, Rhoplex NW-2744F, and Rhoplex TR407M by Rohm and Haas; these can be selected to give desired stiffness, hand, and antifray properties, depending on the T_{g} of the binder used. Other binders, such as Astroclean 26-A, available from Glo-Tex International, Inc. of Spartanburg, S.C., can provide soil release properties as well as conventional binder properties.

Fabrication

Having described in detail the characteristics and construction of the textile composite, the following discussion is directed to process steps for fabricating the textile substrate/adhesive composite.

A non-limiting overview of a fabrication process through which several embodiments of the present textile construction can be produced for use as a wall covering is shown in FIG. 8, in which various process steps are indicated as boxes. Those boxes with dashed lines are considered optional, in that they are required only in the production of specific embodiments. Steps 94 and 102, although not marked as optional, are not always necessary (depending upon the construction of the desired end product). For example, if the yarns comprising the textile substrate are inherently low surface energy yarns (or have been treated to be so via optional Step 80), then Step 94, in which a low surface energy layer is applied to the face of the textile substrate, may not be necessary. Similarly, Step 102, in which an adhesive layer is attached to the back of the textile substrate, is only necessary if the desired end product is the textile substrate/adhesive composite discussed herein. If the adhesive is to be applied at the time of installation, also as discussed herein, then Step 102 would be done at the time of installation (either as a separate step in the installation process, or as a result of being pressed onto a surface to which an adhesive had been applied).

Steps 80 and 82 are directed to the formation of the textile substrate as described herein. Step 80 is useful if the low energy surface of the textile substrate is to be achieved through the use of constituent yarns that individually exhibit—as an inherent property or as a result of a separate treatment—a low energy surface (as opposed to relying upon a low surface energy treatment applied to the textile substrate surface per se). The details of Step 82 depend upon the construction of the textile substrate desired (e.g., woven, knitted, etc.), and reflect conventional fabric formation techniques. Step 84, a conventional heat step indicated as optional, is recommended if the textile substrate is otherwise likely to be dimensionally unstable (e.g., shrink). Steps 86 through 90 may be used to change the aesthetics of the textile substrate, such as through napping, printing, etc. It should be noted that one or more of these steps could be deferred until later in the process. Step 92 is recommended if the textile substrate is likely to exhibit fraying along cut edges, or is in need of stiffening. Step 94, in which a low surface energy finish is imparted to the textile, may be carried out in accordance with the teachings hereinabove and, as mentioned above, may be optional in the case of yarns that already impart an adequate low energy surface to the textile. It should be noted that the use of a binder can interfere with some low surface energy treatments and cause self-sticking. In such cases, it may be advantageous to apply and dry the binder as a separate step, not shown, prior to applying the low surface energy treatment in Step 94. The need for Step 96 depends upon the nature of the preceding process steps and will be apparent to those skilled in the art. In Steps 98 and 100, a primer may be applied to the back of the textile substrate and dried as necessary. For many of the embodiments, these optional steps are recommended. Step 102 is directed to application of the desired adhesive to the back of the textile substrate (if a substrate/adhesive composite is the intended product). Drying Step 104 is necessary only in connection with the use of solvent- or emulsion-type adhesives. Slitting Step 106 involves slitting the textile construction for convenient use, a step that, while technically optional, is recommended if the textile substrate or composite is wider than a few feet.

The present textile construction will further be illustrated by the examples that follow. It should be understood that these examples, which are directed to the textile substrate/adhesive composite embodiment disclosed herein, are representative only and are not intended to be either exclusive or limiting.

### EXAMPLES

The following Examples discuss a variety of tests that were performed in evaluating embodiments involving a substrate/adhesive composite. The test methods and procedures used in these tests are described below.

Adhesive add-on is a measure of the amount of adhesive applied to the textile composite. Clearly, higher numbers indicate the presence of more adhesive on the textile substrate.

Rolling ball tack is a measure of the number of inches a rolling ball will travel across the adhesive surface, when the ball is rolled down an inclined trough within which the ball gains a desired speed. The test was conducted according to ASTM Test Method D-3121-94 (reapproved 1999). Lower distances indicate a surface with greater tack, i.e., with greater instantaneous, short-term adhesion.

The 90-degree peel strength test measures the amount of force (in pounds force/inch) necessary to peel the adhesive-coated textile from a surface. The test was conducted according to ASTM Test Method D-903-98. In this test, the substrate/adhesive composites were adhered, unless otherwise noted, to primed sheetrock using a five-pound roller. Two coats of an interior PVA primer manufactured by Glidden was applied to the surface and allowed to dry prior to the application of the substrate/adhesive composite.

The substrate/adhesive composite was then removed from the sheetrock, with a measurement being made of the force necessary for removal.

The delamination strength test measures the amount of force (in pounds force/inch) necessary to separate the textile substrate from the adhesive component. In this test, the adhesive component of the composite was glued to sheetrock using an epoxy adhesive. The textile substrate was then removed from the adhesive component, with a measurement being made of the force necessary for removal. Typical failure modes observed were cohesive (i.e., the adhesive layer failed and became internally separated) or at the substrate/adhesive interface (e.g., the bond between the adhesive and the substrate failed, causing the adhesive to remain attached to the surface and to become separated from the substrate).

### Example 1

### Evaluation of Tear Strength and Burst Strength

Tear strength of different textile substrates was evaluated, using ASTM Test Method D-5733-99. Tear strength is the force required either to start or to continue a tear in a substrate.

Burst strength is a test that measures the bursting strength of a substrate. The procedure was conducted in accordance with ASTM Test Method D-3787-89.

The textile substrates and competitive products tested are described below, and the corresponding results are shown in Data Table 1.

| | |
|---|---|
| Component 1A: | 2 × 2 basket weave; 100% polyester; warp having 3/150/34 polyester |
| | yarns and 64 ends/inch; fill having 3/150/34 polyester yarns and 44 |
| | picks/inch |
| Component 1B: | plain woven 100% polyester textile; warp having 3/150/50 polyester |
| | yarns and 39 ends/inch; fill having 3/150/50 polyester yarns and 41 |
| | picks/inch; finished weight of 6.34 ounces/yd² |
| Component 1C: | H crepe weave; 100% polyester; warp having 2/150/34 polyester yarns |
| | and 67 ends/inch; fill having 2/150/34 polyester yarns and 46 picks/inch; |
| | finished weight of 6.38 ounces/yd² |
| Component 1D: | 6H crepe weave; 100% polyester; warp having 1/150/36 polyester yarns |
| | and 66 ends/inch; fill having 1/150/36 polyester yarns and 54 picks/inch |
| Component 1E: | Fancy weave; 100% polyester; warp having 1/300/136 polyester yarns |
| | and 64 ends/inch; fill having 2/150/68 polyester yarns and 68 picks/inch; |
| | finished weight of 6.21 ounces/yd² |
| Component 1F: | Plain weave taffeta; 100% polyester; warp having 1/150/36 polyester |
| | yarns; fill having 1/150/36 polyester yarns |
| Component 1G: | Hydro entangled spun lace no woven; 100% polyester; randomly carded |
| | polyester |
| Component 1H: | Mock leno weave; 100% polyester; warp having 1/070/34 polyester yarns |
| | and 103 ends/inch; fill having 1/070/36 polyester yarns and 86 |
| | picks/inch; finished weight of 2.31 ounces/yd² |
| Component 1I: | Double-knit construction containing 2/150/68 Danbury-textured 100% |
| | polyester yarns, 1/150/72 100% polyester yarns, and 1/150/36 100% |
| | polyester yarns; 8.7 ounces/yard² |
| Component 1J: | Single needle bar knit contruction; 1/150/34 yarns of 100% polyester; |
| | 7.5 ounces/yard² |
| Competitive Product A: | Duct tape, sold under the Duck ® brand by Henkel Consumer Additives |
| Competitive Product B: | Masking tape, sold under the name “Anchor II Advanced Adhesives” by |
| | Anchor Continental |
| Competitive Product C: | A self-stick wallpaper border, sold under the name “SofTac Adhesive |
| | Border” by D. W. Wallcovering |
| Competitive Product D: | A self-stick wallpaper border, sold under the name “Stick'nPlay Self-Stick |
| | Activity Border” by Imperial Home Décor Group. |

DATA TABLE 1

| | | |
|---|---|---|
| Machine | Cross-Machine | |
| Direction Tear | Direction Tear | Burst Strength |
| (lbf) | (lbf) | (lbf) |

Textile Substrates

| | | | |
|---|---|---|---|
| Component 1A | 136.3 | 85.6 | 417.2 |
| Component 1B | 57.6 | 50.3 | 338.3 |
| Component 1C | 57.6 | 42.3 | 361.2 |
| Component 1D | 35.2 | 25.8 | 201.8 |
| Component 1E | 25.7 | 51.1 | 252.2 |
| Component 1F | 20.3 | 15.1 | 167.9 |
| Component 1G | 16.1 | 11.4 | 78.3 |
| Component 1H | 11.0 | 13.8 | 139.9 |
| Component 1I | 39.5 | 44.4 | not evaluated |
| Component 1J | 48.1 | 31.9 | not evaluated |

Competitive Products

| | | | |
|---|---|---|---|
| Duct Tape | 6.1 | not evaluated | not evaluated |
| Masking Tape | 0.9 | not evaluated | not evaluated |
| Wallpaper Border | 2.8 | 2.1 | 8.3 |
| No. 1 | | | |
| Wallpaper Border | <0.5 | <0.5 | not evaluated |
| No. 2 | | | |

### Example 2

### Effect of Different Textile Substrates

The following procedure was used to create the substrate/adhesive composites of this Example.

The textile substrate was dipped into a bath containing a low surface energy composition comprising, by percent weight of the bath:
4.25% UNIDYNE® TG-992 fluorinated stain release agent
1.00% REPEARL® F-8025 fluorocarbon repellent
1.25% RESIN MRX® block diisocyanate cross-linking agent

The substrate was squeezed through pad rolls to achieve a wet pick-up of approximately 50%. The substrate was subsequently dried and heat-set on a tenter frame at 390° F. at a rate of 40 yards per minute.

The dried substrate was transfer printed on the face side.

The back of the printed substrate was coated with ROBOND© PS-8120 HV pressure sensitive adhesive, using one of a number of laboratory wire-wound rod coaters. Each of the coated substrate samples was then dried at 250° F. in a lab-scale Despatch oven.

The textile substrates used to make the substrate/adhesive composites are described below.

| | |
|---|---|
| Composite 2A: | double-knit construction containing 2/150/68 Danbury- |
| | textured 100% polyester yarns, 1/150/72 100% polyester |
| | yarns, and 1/150/36 100% polyester yarns; 8.7 ounces/ |
| | yard² |
| Composite 2B: | single needlebar knit construction; 1/150/34 yarns |
| | of 100% polyester; 7.5 ounces/yard² |
| Composite 2C: | twill woven construction; warp of 14/1 open end spun |
| | 65/35 polyester/cotton staple fibers with 3.30 twist |
| | multiple; fill of 12/1 open end spun 65/35 polyester/ |
| | cotton staple fibers with 3.25 twist multiple; 8.5 |
| | ounces/yard² |
| Composite 2D: | woven rip-stop construction; 100% nylon (40 denier |
| | yarns) |
| Composite 2E: | hydroentangled spunbonded/spunlace nonwoven |
| | comprised of conjugate polyester/nylon fibers that |
| | have been split into microdeniers having an average |
| | filament size of 0.2 denier/filament; 80 g/m² |

The textile substrates of Composites 2A and 2B are automotive body cloth, which were treated, before application of the adhesive, with flame retardants and UV stabilizers to enhance the composite's ability to meet flammability and lightfastness requirements.

Composites 2A-2E were compared to a sample created using a substrate described as Composite 4C, which will be discussed presently. Briefly, Composite 4C is a 100% polyester cross-hatch woven textile substrate that was coated on the back with a wire wound rod coater with a No. 40 size rod.

Composites 2A-2E were tested using the Rolling Ball Tack and 90-Degree Peel Strength tests outlined previously. The results, as are shown in Data Table 2, were compared with those from Example 4C.

DATA TABLE 2

| Sample | Rolling Ball Tack | 90-Degree Peel |
|---|---|---|
| (description) | (inches) | (lbf/inch) |
| Composite 2A | 12 | 0.38 |
| (knit, polyester) | | |
| Composite 2B | 12 | 0.13 |
| (knit, polyester) | | |
| Composite 2C | 12 | 0.01 |
| (twill woven, | | |
| poly/cotton) | | |
| Composite 2D | 4.7 | 0.67 |
| (woven, nylon) | | |
| Composite 2E | 3.3 | 1.00 |
| (nonwoven, polyester) | | |
| Composite 4C | 4.5 | 0.60 |
| (woven, polyester) | | |

The surface contour of the textile substrate appears to have a significant influence on the rolling ball tack results. It is believed that this trend is attributable to the application method used, which tends to push the adhesive into the “valleys” of the substrate rather than allowing it to remain on the surface yarns. This result allows a ball rolling on the surface to contact less adhesive and, therefore, roll further (as evidenced in the comparison between Composite 2C and 4C, Composite 2C being more contoured by its twill weave construction).

Similarly, perhaps, the localized placement of the adhesive may also be responsible for the lower peel strengths of Composites 2A, 2B, and 2C. The contours of these textile substrates are such that there is less surface contact between the adhesive component and the wall. Accordingly, the substrate/adhesive composite requires less force to remove.

Modification of the surface contours of the textile substrates (for example, by surface finishing or through various substrate constructions) or increasing the level of add-on may each contribute to an increase in tack and peel strength.

### Example 3

### Effect of Different Adhesives

Plain weave 100% polyester textile substrate was treated with release/repel formulation and transfer printed as in Example 2. Three separate adhesives were applied:
Composite 3A: ROBOND© PS-8120 HV methacrylic-based adhesive
Composite 3B: MULTI-LOK® 38-454A acrylic adhesive
Composite 3C: NACOR® 72-8761 vinyl acetate adhesive

Adhesive compositions were coated on the rear face of the polyester textile substrate with a No. 40 wire wound rod and dried in an oven at 121° C. (250° F.) for 10 minutes. The samples were tested for delamination strength, 90-degree peel strength, and rolling ball tack as described above. In particular, 90-degree peel strength was measured for the samples applied to unprepared sheetrock.

DATA TABLE 3

| | Adhesive | Rolling Ball | 90-Degree | Delamination |
|---|---|---|---|---|
| | Add-on | Tack | Peel Strength | Strength |
| Sample | (g/m²) | (inches) | (lbf/inch) | (lbf/inch) |
| Composite 3A | 60.0 | 5.5 | 0.15 | 0.87 |
| Composite 3B | 50.1 | 12+ | 0.32 | 3+ |
| Composite 3C | 63.6 | 8.25 | 0.67 | not evaluated |

These results indicate the ability to modify the adhesive properties of the composite by selection of specific adhesives.

### Example 4

### Evaluation of Different Adhesive Add-On Levels; Comparison with Commercially Available Products

A woven textile substrate having a warp made of 2/150/36 100% polyester yarns with 80 ends/inch and a fill made of 2/150/66 100% polyester yarns with 50 picks/inch was formed in a cross-hatch weave construction. Both of the polyester yarns used were inherently flame retardant. The substrate weight was about 5 ounces/yard².

Four sizes of wire-wound rod coaters were used: a No. 22 rod, a No. 30 rod, a No. 40 rod, and a No. 60 rod. The samples produced by each of these rods are further identified below as 4A, 4B, 4C, and 4D, respectively.

Data Table 4.1 shows the results of a series of tests conducted on the four samples to measure (a) adhesive add-on amount; (b) rolling ball tack; (d) 90-degree peel strength; and (d) delamination force. The tests were conducted according to the procedures outlined above.

DATA TABLE 4.1

| | | | Rolling | | |
|---|---|---|---|---|---|
| | | Adhesive | Ball | 90-Degree | Delamination |
| | Rod | Add-on | Tack | Peel | Strength |
| Sample | No. | (g/m²) | (inches) | (lbf/inch) | (lbf/inch) |
| Composite 4A | 22 | 45 | 11.9 | 0.14 | 0.81 |
| Composite 4B | 30 | 53 | 7.6 | 0.3 | 0.93 |
| Composite 4C | 40 | 59 | 4.5 | 0.6 | 0.96 |
| Composite 4D | 60 | 75 | 3.7 | 0.82 | 1.05 |

Adhesive add-on level is variable, depending on the application technique used to apply the adhesive. Rolling ball tack ranged from 3.7 inches to 11.9 inches. 90-degree peel strength ranged from 0.14 lbf/inch to 0.82 lbf/inch. Delamination strength ranged from 0.81 lbf/inch to 1.05 lbf/inch.

As the adhesive add-on level increases, rolling ball tack decreases and 90-degree peel increases. This indicates that the adhesive properties can be adjusted over a reasonable range by controlling the adhesive add-on, thus facilitating the creation of a repositionable, removable substrate/adhesive composite.

Further, because the delamination strength is greater than the 90-degree peel for each of the four samples, the substrate/adhesive composite can be removed from surfaces without significant transfer of the adhesive from the substrate to the surface to which it was adhered.

Rolling ball tack and 90-degree peel strength were also measured for some commercially available adhesive products: duct tape (sold under the Duck® brand by Henkel Consumer Additives), masking tape (sold under the name “Anchor II Advanced Adhesives” by Anchor Continental), and two self-stick wallpaper borders (the first of which was sold under the name “SofTac Adhesive Border” by D.W. Wallcovering and the second of which was sold under the name “Stick'nPlay Self-Stick Activity Border” by Imperial Home Decor Group). Results are shown below in Data Table 4.2.

DATA TABLE 4.2

| | Rolling Ball Tack | 90-Degree Peel |
|---|---|---|
| Adhesive Product | (inches) | (lbf/inch) |
| Duct tape | 3 | 1.16 |
| Masking tape | 12 | 1.07 |
| Wallpaper border No. 1 | 9 | 0.59 |
| Wallpaper border No. 2 | 10 | 0.22 |

A comparison of the rolling ball tack and 90-degree peel strength with the examples of Data Table 4.1 indicates that the present substrate/adhesive composites can be engineered to have properties similar to those in other commercially available products.

### Example 5

### Water Vapor Transmission

The water vapor permeability of various wall coverings were tested via ASTM E 96-95. In this test, the mouths of water filled jars were securely covered with the substrate (or, in some cases, the substrate/adhesive composite) to be tested. The covered jar was weighed and then placed in a constant humidity room at 70° F. and 65% relative humidity for 24 hours. Afterward, the jar was re-weighed. The difference between the initial and final weighing, divided by the area of the jar mouth, represents the water vapor transmission per area per day.

Four substrate/adhesive composites were prepared using various polyester textile substrates and adhesives. Sample 5A was a Jacquard woven textile substrate coated with ROBOND© PS 8120 HV adhesive thickened with 0.5% ACRYSOL© ASE-60. Sample 5B was the same Jacquard woven textile substrate, this time coated with NACOR© 72-8761 adhesive thickened with 1.0% ACRYSOL© TT-615. Samples 5C and 5D were plain woven polyester textile substrates coated with ROBOND© PS 8120 HV adhesive thickened with 0.5% ACRYSOL© ASE-60. Samples 5A through 5D were treated with the low surface energy composition of Example 2. Sample 5E was the test control in which no cover is placed over the evaporation jar. Sample 5F was a commercial vinyl wall covering. Sample 5G was the same textile substrate as in Example 12, with a hot melt adhesive. Sample 5H used the same textile substrate as Samples 5A and 5B; Sample 5H, however, had no adhesive layer.

DATA TABLE 5

| | | Adhesive | Water Vapor |
|---|---|---|---|
| | | Add-on | Transmission |
| ID | | oz/yd² | g/m²/day |
| No. 5A | Jacquard Woven Textile | 4.01 | 66.1 |
| | Substrate No. 1 w/ROBOND © | | |
| No. 5B | Jacquard Woven Textile | 3.81 | 88.1 |
| | Substrate No. 2 w/NACOR © | | |
| No. 5C | Plain Woven Textile | 3.38 | 44.1 |
| | Substrate No. 1 w/ROBOND © | | |
| No. 5D | Plain Woven Textile | 3.47 | 66.1 |
| | Substrate No. 2 w/ROBOND © | | |
| No. 5E | CONTROL - No cover | 0 | 2026.4 |
| No. 5F | Commercial Vinyl Wallcovering | 0 | 0.0 |
| No. 5G | Same textile substrate | Not | 44.05 |
| | as Ex. 12, w/hot melt | Determined | |
| No. 5H | Jacquard Woven Textile | 0 | 506.61 |
| | Substrate No. 1 w/no adhesive | | |

As shown by the data, the water vapor transmission (i.e., moisture transport) of the substrate/adhesive composites is far greater than commercial vinyl wall covering. The expected benefit is that any water that collects behind the wallboard will be able to migrate through the wallboard and through the wall covering, rather than becoming trapped as in the case of vinyl wall coverings and promoting the growth of mold, degrading the adhesion between the wall covering and the wall, or otherwise contributing to undesirable results.

### Example 6

### Effect of Different Processing Conditions on Delamination Strength

A plain weave 100% polyester textile substrate was treated with release/repel formulation and transfer printed as in Example 2. Six variations of processing conditions were tested using ROBOND© PS-8120 HV acrylic emulsion adhesive. The processing conditions used were as follows:

| | |
|---|---|
| Composite 6A: | Apply adhesive and dry at 121° C. for 10 minutes |
| Composite 6B: | Apply adhesive and dry at room temperature for 48 hours |
| Composite 6C: | Apply adhesive and dry at 149° C. for 10 minutes |
| Composite 6D: | Apply adhesive and dry at room temperature for 48 |
| | hours, then heat to121° C. for 10 minutes |
| Composite 6E: | Abrasive finishing of rear surface using 600 grit diamond |
| | roll for 24 passes according to process in U.S. Pat. No. |
| | 6,233,795, followed by the application of adhesive |
| | and drying at 121° C. for 10 minutes |
| Composite 6F: | Abrasive finishing of rear surface using 1200 grit |
| | diamond roll for 24 passes according to process in |
| | U.S. Pat. No. 6,233,795, followed by the application |
| | of adhesive and drying at 121° C. for 10 minutes |
| Composite 6G: | Apply adhesive and dry at 121° C. for 10 minutes, |
| | followed by heating in transfer printing press at 400° F. |
| | for 1 minute to reproduce the effects of transfer printing |

Adhesives were applied with a No. 40 wire wound rod. The samples were tested for delamination strength as in Example 2, the results of which are recorded in Data Table 6.

DATA TABLE 6

| | Adhesive Add-on | Delamination Strength |
|---|---|---|
| Sample | (g/m²) | (lbf/inch) |
| Composite 6A | 55.6 | 0.95 |
| Composite 6B | 55.0 | 0.72 |
| Composite 6C | 58.6 | 0.93 |
| Composite 6D | 60.5 | 0.96 |
| Composite 6E | 59.4 | 1.14 |
| Composite 6F | 57.3 | 1.08 |
| Composite 6G | 56.5 | 0.99 |

Tests of the default processing conditions described by Composite 6A showed acceptable adhesive performance, with a 90-degree peel strength of 0.60.

However, when air drying was used as in Composite 6B, samples applied to primed wall surfaces exhibited bubbles where the textile substrate delaminated from the adhesive layer and left residue on the wall after removal. This can be explained in terms of the delamination strength of the adhesive being too close to the peel strength for air-dried composites.

Various other processing conditions (Composites 6C through 6G) have been demonstrated to further increase the gap between delamination and 90-degree peel strength, thereby reducing the chance of undesirable delamination of adhesive during use.

When engineering an adhesive to have appropriate level of peel strength, it is important to consider the nature (i.e., smoothness) of the surface to which the substrate/adhesive composite will be applied. It is well known that the nature of the surface strongly affects the peel strength of the adhesive bond. For example, rough, fibrous, or hydrophobic surfaces decrease peel strength, while smooth, hydrophilic surfaces tend to increase peel strength. In all cases, it is desirable to have the delamination strength of the composite be higher than the peel strength.

The results of this Example show various processing methods that may be used to ensure that the delamination strength remains sufficiently higher than the anticipated peel strength, given the characteristics of a surface to which the composite will likely be removably adhered.

### Example 7

### Effect of Different Adhesive Additives

A plain weave 100% polyester textile substrate was treated with a low surface energy formulation and transfer printed as in Example 2. Eight adhesive compositions were made by combining single adhesive additives with ROBOND© PS-8120 HV acrylic emulsion adhesive. The additives used were:
Composite 7A: Control; no additive
Composite 7B: 1 wt % UNIDYNE® TG-992 fluorochemical
Composite 7C: 5 wt % ROVACE® 117 hardener/detackifier
Composite 7D: 10 wt % ROVACE® 117 hardener/detackifier
Composite 7E: 1 wt % RESIN MRX® block diisocyanate cross-linking agent
Composite 7F: 1 wt % SURFONYL® PSA-336 wetting agent
Composite 7G: 0.5 wt % ACRYSOL® ASE-60 thickener
Composite 7H: 1 wt % ACRYSOL® ASE-60 thickener

Adhesive compositions were coated on the rear face of the polyester textile substrate with a. No. 40 wire wound rod and dried in an oven at 121° C. (250° F.) for 10 minutes. The samples were tested for delamination strength, 90-degree peel strength, and rolling ball tack as in Example 2. In particular, 90-degree peel strength was for the samples applied to unprepared wallboard.

DATA TABLE 7

| | Adhesive | Rolling Ball | 90-Degree | Delamination |
|---|---|---|---|---|
| | Add-on | Tack | Peel Strength | Strength |
| Sample | (g/m²) | (inches) | (lbf/inch) | (lbf/inch) |
| Composite 7A | 60.0 | 5.5 | 0.15 | 0.87 |
| Composite 7B | 55.3 | 12+ | not evaluated | 0.99 |
| Composite 7C | 58.0 | 9.75 | not evaluated | 1.09 |
| Composite 7D | 58.0 | 11 | not evaluated | 1.32 |
| Composite 7E | 55.2 | 7.25 | 0.01 | 1.31 |
| Composite 7F | 60.8 | 9.5 | 0.10 | 1.30 |
| Composite 7G | 57.7 | 7.25 | 0.26 | not evaluated |
| Composite 7H | 64.1 | 8.24 | 0.18 | 1.47 |

These tests illustrate the ability to modify adhesive properties through judicious use of additives. In particular, certain compositions (7F and 7H) were shown to improve the delamination strength of the adhesive without negatively affecting the 90-degree peel strength.

### Example 8

### Effect of Adhesive Penetration Depth

An adhesive composition containing 1% ACRYSOL® ASE-60 thickening agent in ROBOND© PS-8120 HV acrylic pressure sensitive adhesive was applied to two plain weave 100% polyester textiles that had different types of hydrophobic surfaces. The textile substrate of Composite 8A was prepared as in Example 2. The textile substrate of Composite 8B was the same greige substrate as in Example 2, but it was not treated with low surface energy chemistry.

The adhesive composition was coated on the rear face of the textile substrates with a No. 40 wire wound rod, after which the adhesive-applied substrate was dried in an oven at 121° C. (250° F.) for 10 minutes to create a substrate/adhesive composite. Composites 8A and 8B were tested for delamination strength, using the technique previously described.

DATA TABLE 8

| | Adhesive Add-on | Delamination Strength |
|---|---|---|
| Sample | (g/m2) | (lbf/inch) |
| Composite 8A | 64.1 | 1.47 |
| (with low surface energy | | |
| chemistry) | | |
| Composite 8B | 80 (est.) | 2.36 |
| (without low surface energy | | |
| chemistry) | | |

In Composite 8A, the majority of the adhesive remained as a discrete surface layer on the substrate while in Composite 8B, the majority of the adhesive penetrated into the substrate. The greater penetration of the adhesive into the substrate resulted in much higher delamination strength and illustrates the ability to improve delamination strength by increasing penetration of adhesive into the substrate. An additional observed benefit of increased adhesive penetration is a decrease in the tendency of the substrate/adhesive composite to unravel at cut edges.

### Example 9

### Effect of Accelerated Aging Present Composites vs. Commercially Available Products

This set of tests was designed to determine the ability of the present substrate/adhesive composite to withstand aging. For comparison, the textile substrate and wallpaper borders used in Example 4 were also subjected to the same test conditions and evaluated.

The backs of the substrates were coated with ROBOND© PS-8120 HV pressure sensitive adhesive, using one of a number of laboratory wire-wound rod coaters. Three sizes of wire-wound rod coaters were used: a No. 30 rod, a No. 40 rod, and a No. 50 rod. The samples produced by each of these rods are further identified below as 9A, 9B, and 9C, respectively. Each of the coated substrate samples was then dried at 250° F. in a lab-scale Despatch oven.

The substrate/adhesive composites and the two wallpaper borders were applied to paint-primed sheetrock using a five-pound roller. The samples were tested for 90-degree peel strength 24 hours after application. Multiple samples were aged simultaneously, using the process of ASTM Test Method D-3611-89, where five samples of each were tested after 240 hours and the remaining five samples of each were tested after 480 hours. Test conditions were 80% relative humidity and a temperature of 150° F. After 240 hours and 480 hours of accelerated aging, the samples were equilibrated to room temperature and the 90-degree peel strength test was conducted. The averaged results are shown in Data Table 9.

| | DATA TABLE 9 | | |
|---|---|---|---|
| | 90-Degree Peel Strength (lbf/inch) | | |
| Sample | Initial | After 240 Hours | After 480 Hours |
| Wallpaper border No. 1 | 0.59 | 1.12 | 1.02 |
| Wallpaper border No. 2 | 0.22 | 0.88 | 0.75 |
| Composite 9A | 0.30 | 0.43 | 0.33 |
| Composite 9B | 0.60 | 1.12 | 0.70 |
| Composite 9C | 0.50 | 0.51 | 0.74 |

All of the samples remained affixed to the sheetrock after exposure to the test conditions, indicating that the samples will remain attached for 5 to 10 years of use (represented by 240 hours and 480 hours of accelerated aging, respectively). All of the samples tested required more force to remove after 480 hours of accelerated aging than each did initially. However, the composites of the present disclosure experienced more long-term adhesive stability than did the wallpaper borders. Further, whereas the wallpaper borders were destroyed during the peel strength tests, each of the substrate composites was removed in a monolithic unit with no tearing.

In a separate trial conducted using ASTM Test Method D-3611-89, a strip of Composite 9B having an approximate size of 1 inch by 40 inches was wrapped tightly around a wooden, 1/4 inch diameter dowel and aged. After both 240 hours and 480 hours, the composite easily unwound without becoming adhered to itself. The unwound composite also retained its adhesive characteristics.

### Example 10

### Effect of Low Surface Energy Treatment on Roll-Up

To test the effect of a low surface energy treatment on the ability to roll-up the substrate/adhesive composite, the following experiment was conducted.

A substrate/adhesive composite was prepared, according to Example 6A, using ROBOND© PS8120 HV acrylic emulsion adhesive on a 100% polyester woven textile substrate.

A 2×6 in strip of the substrate/adhesive composite was adhered to two substrate surfaces, one of which (Surface 10A) was treated with the release chemistry of Example 2 and one of which (Surface 10B) was untreated. The substrate surfaces were otherwise identical. The 90-degree peel strength was measured, according to the previous description, to determine the amount of force required to remove the composite from a substrate surface (designed to mimic the substrate/adhesive composite in its rolled-up form).

The results are shown in Data Table 10.

DATA TABLE 10

| | 90-Degree |
|---|---|
| | Peel Strength |
| Example | (lbf/inch) |
| Surface 10A (treated with release chemistry) | 0.0023 |
| Surface 10B (not treated with release chemistry) | 0.0155 |

For both surfaces, the peel strength was much lower than the observed 90-degree peel strength from a non-textile surface (e.g., primed sheetrock). That is, the force required for self-release in these cases, where hydrophobic surfaces are present, is much lower than force required for removal of the substrate/adhesive composite from a non-textile surface. This translates to a product that is easy to unroll during installation.

### Example 11

### Use of Tufted Textile in Composite

A tufted textile substrate (i.e., a carpet substrate), comprised of a plurality of olefin yarns tufted through a nonwoven substrate, was used to create a substrate/adhesive composite. On the rear surface of the nonwoven substrate was a polyurethane film, to which ROBOND© PS-8120 HV acrylic pressure sensitive adhesive was applied. The weight of the tufted textile substrate was about 0.83 g/in². The tufted substrate/adhesive composite was adhered to a vertical wall surface and showed no problems with delamination or with inability to remain adhered.

### Example 12

### Use of Thermoplastic Hot-Melt Polymer

A woven textile substrate was prepared according to the Example of U.S. Pat. No. 6,541,402, to Kimbrell, Jr. et al., the details of which are as follows. A woven textile substrate having a 150 denier warp with 133 ends and a 690 denier (textured) fill with 45 ends was formed from solution dyed nylon yarn (available from Cookson Fibers under the trade name Camac™) on a Jacquard loom to yield a 100% Jacquard weave nylon woven textile substrate.

The loom state textile substrate was thereafter scoured and thereafter padded on both sides with a solution containing about 1%40% (about 6.6% preferred) of a fluorochemical such as REPEARL® F-8025; about 0.5%-5.0% (about 3.0% preferred) ULTRA-FRESH NM™; and about 0.05%-1.0% (about 1.0% preferred) ULTRA-FRESH 40™ (antimicrobial agents, both available from Thompson Research) with the remainder of the solution being made up of water.

While in the preferred practice, this solution will include an antimicrobial component, it is to be understood and appreciated that one or more of these additional components may be eliminated if desired. Following the padding application of this preparation solution, the textile substrate was cured at a temperature within the range of about 225° F. to 425° F. (about 350° F. preferred) for 60 seconds. The woven textile substrate substrate with applied fluorochemical stain resist agent was thereafter heated to a temperature within the range of about 90° F. to 410° F. (about 225° F. preferred) and passed to an extrusion coater.

As will be appreciated by those of skill in the art, extrusion coating involves the process of extruding a molten film from a die and contacting this molten film with the textile substrate under pressure in the nip of two counter-rotating rolls. According to the preferred practice, one of these rolls was a chill roll, which was in contact with the surface being coated while the other roll was a deformable rubber material, which was in contact with the side remaining uncoated. Through use of such a configuration, a layer of molten ethylene methyl acrylate (EMA) having 20% MA substitution on the ethylene backbone, was spread across and forced into the textile substrate which had undergone fluorochemical treatment. This molten EMA is preferably applied at a temperature of about 580° F. while the chill roll is preferably held at a temperature of about 55° F. One potentially preferred (EMA) composition is EMA 806-009, available from Equistar Chemicals of Cincinnati, Ohio, which includes an elastomeric component therein.

Necessarily injected within the manufacturing operation was a wax or wax-like chemical, which acts as a release agent for the EMA when in contact with the chill roll. Such a chemical, such as Acrawax™ from Lonza Chemical, thus allows for a continuous, clean application of the preferred EMA, which, without a release agent, would remain contacted with the chill roll and “gum up” the extrusion apparatus. The line speed of the substrate itself is preferably about 100 feet per minute through the machine. This operation leads to a configuration wherein the EMA coating substantially covers and surrounds the yarn of the textile substrate over a large surface area so as to promote good mechanical adhesion. In the preferred practice, the total thickness of the applied barrier layer is between about 1.00 and 5.00 mils, preferably between about 1.50 and 2.50 mils, and most preferably between about 1.75 and 2.25 mils.

The resulting product has a high degree of stain repellency and possesses anti-fungal and anti-bacterial properties. The polymeric adhesive layer, consisting of thermoplastic hot-melt polymer, is not tacky at room temperature.

A sample of this composite was ironed onto primed sheetrock with a Sunbeam iron set to the setting recommended for nylon textiles.

The 90-degree peel strength, when removed after heating, was 0.70 lbf/inch, indicating sufficient adhesion to remain fixed to a surface.

### Example 13

### Stability to Humidity Variations

The stability of substrate/adhesive composites with respect to changes in humidity was investigated. Two substrate/adhesive composites were prepared using two different PET textile substrates coated with ROBOND© PS 8120 HV adhesive thickened with 0.5% Acrysol ASE-60. Sample 13A was a Jacquard woven and Sample 13B was a plain woven. Ten 1×10 inch test strips were made of each composite and applied to primed wallboard with a 5 lb roller. The primer was Shieldz Universal Pre-Wallcovering Primer by Zinsser. Five test strips of each composite were tested for 90° peel strength after conditioning for 24 hrs at room temperature. The remaining five test strips of each composite were placed in a humidity controlled chamber and exposed to a temperature and humidity cycle. Each cycle consisted of four temperature and relative humidity stages as described in the following Table:

| | Stage duration | Temperature | Relative |
|---|---|---|---|
| Stage | (hour) | (° F.) | Humidity (%) |
| 1 | 29 | −40 | Ambient |
| 2 | 19 | 72 | 95 |
| 3 | 29 | 225 | Ambient |
| 4 | 19 | 72 | 95 |

The samples were then conditioned at room temperature for 24 hrs and then tested for 90° peel strength. The results are summarized in the following Table.

| | Adhesive | | Humidity Cycled | % Peel |
|---|---|---|---|---|
| | Add-on | Average 90° peel | Averaged 90° | Strength |
| ID | (oz/yd2) | (lbf/in) | peel (lbf/in) | Increase |
| No. 13A | 3.81 | 0.898 | 2.084 | 232% |
| No. 13b | 4.31 | 0.402 | 0.637 | 158% |

The adhesive composites were observed to increase in peel strength after undergoing heat and humidity aging. In some cases, notably in some Sample 13A test strips, the front of the wallboard peeled off during testing. This was attributed to the exposure of the uncoated sides of the wallboard to condensation during the test, which leads to weakening in a manner that is not anticipated in practice.

1. A moisture permeable, non-self-adhering substrate/adhesive composite having a face and a back, said face comprising a textile substrate having a low energy surface and said back comprising an adhesive.
